(19) United States
(12) Patent Application Publication
(10) Pub. No.: US 2011/0289250 A1
(43) Pub. Date: Nov. 24, 2011

(54) CARD ADAPTER

(75) Inventor: HUI LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (TW)

(21) Appl. No.: 12/819,411

(22) Filed: Jun. 21, 2010

(30) Foreign Application Priority Data
May 21, 2010 (CN) 201010179543.6

(51) Int. Cl. G06F 13/00

(52) U.S. Cl. 710/301

(57) ABSTRACT

A card adapter includes a printed circuit board (PCB). The PCB includes a first memory slot to receive a memory module to be corrected, a connecting portion with several golden fingers to insert into a second memory slot of a computer system, and first and second switches. The memory slot of the PCB includes several terminals corresponding to pins of a serial presence detect (SPD) chip of the memory module. The golden fingers correspond to pins of the second memory slot. The first switch is set between the terminal corresponding to the serial data signal pin of the memory module and the golden finger corresponding to the serial data signal pin of the second memory slot. The second switch is set between the terminal corresponding to the serial clock signal pin of the memory module and the golden finger corresponding to serial clock signal pin of the second memory slot.

### BACKGROUND

1. Technical Field

The present disclosure relates to card adapters, and more particularly to a card adapter for correcting serial presence detect (SPD) data in a SPD chip of a memory module.

2. Description of Related Art

Most memory modules include SPD chips, for storing data of the corresponding memory module, such as timing parameters, manufacturers and serial numbers. A computer system runs properly when the matched SPD data is read from the SPD chip by the basic input output system (BIOS) of the computer system.

The SPD chip usually stores conservative SPD data to match most computer systems. In some situation, programs such as SPD Tool are used to read and modify the SPD data. However, once the SPD data is wrongly modified, the computer system cannot run properly.

In order to correct the SPD data of the memory module, a standard memory module is inserted in a memory slot of the computer system, the SPD data is read and saved by the computer system. Then, the memory module to be corrected is inserted into another memory slot of the computer system in a hot-plug manner, and is corrected according to the SPD data of the standard memory module. However, the memory module to be corrected may be easily damaged due to a transient voltage spike.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an exemplary embodiment of a card adapter.

FIG. 2 is similar to FIG. 1, but viewed from a reverse perspective.

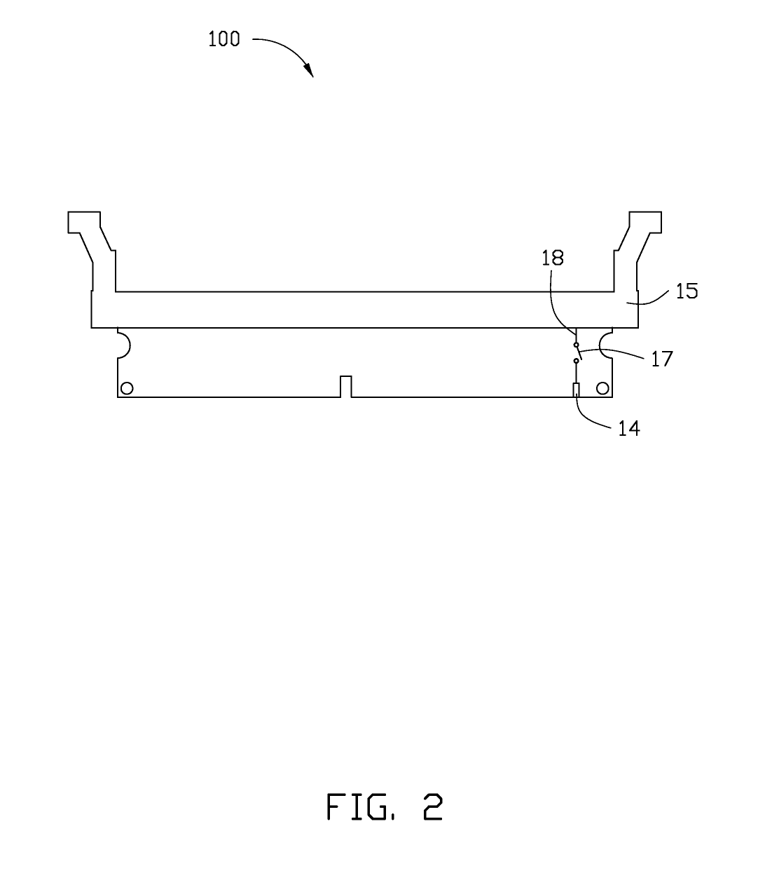

FIG. 3 is a schematic diagram of the card adapter of FIG. 2 connected to a memory slot of a computer system and a memory module to be corrected.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

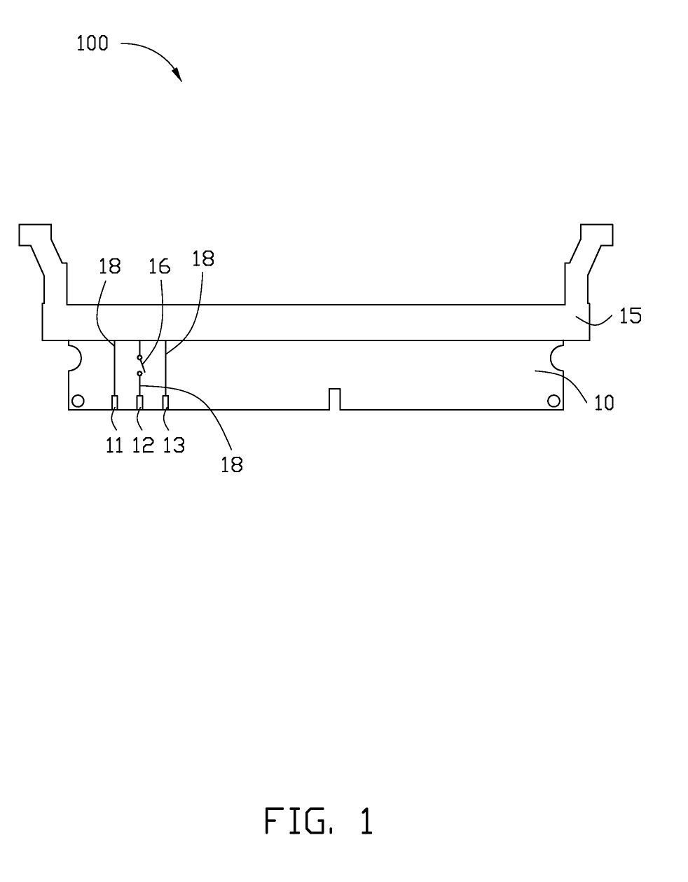

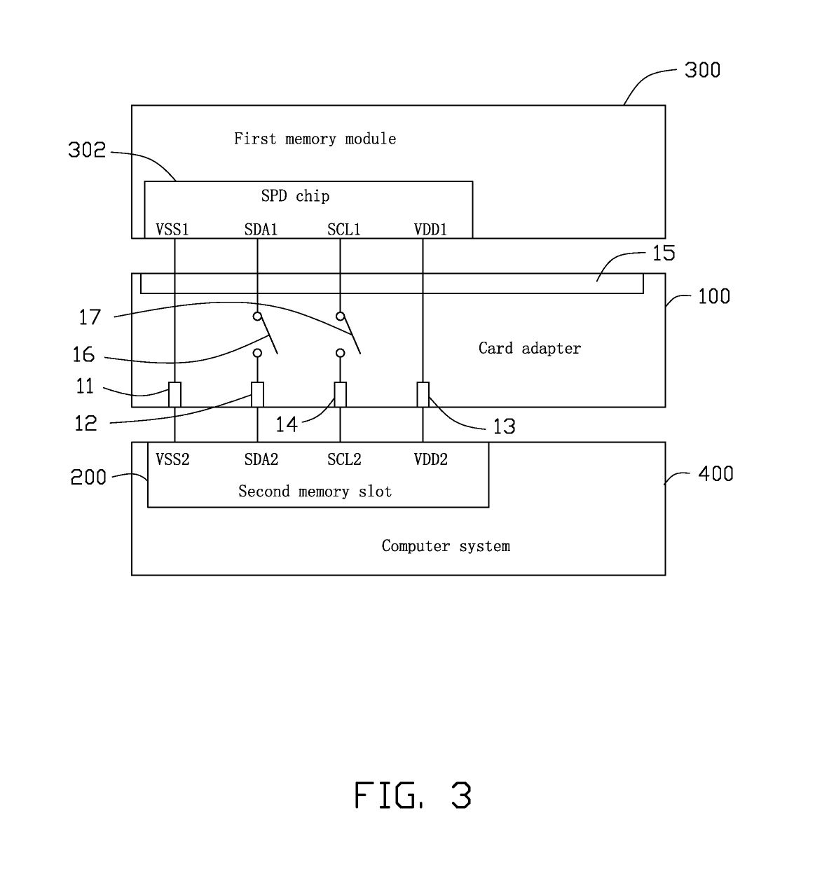

Referring to FIGS. 1 and 3, an exemplary embodiment of a card adapter 100 is operable to insert into one of memory slots 200 of a computer system 400 to correct incorrect SPD data in a memory module 300. The card adapter 100 includes a printed circuit board (PCB) 10. The PCB 10 includes a connecting portion with golden fingers 11-14 formed in the lower portion, a memory slot 15 is formed in the upper portion, a first switch 16, and a second switch 17. The golden fingers 11-14 corresponds to a ground pin VSS2, a power pin VDD2, a serial data signal pin SDA2, and a serial clock signal pin SCL2 of the memory slot 200. The memory slot 15 includes a plurality of terminals corresponding to a ground pin VSS1, a power pin VDD1, a serial data signal pin SDA1, and a serial clock signal pin SCL1 of a SPD chip 302 of the memory module 300. The first switch 16 is connected between the terminal corresponding to the serial data signal pin SDA1 of the memory module 300 and the golden finger 12 corresponding to the serial data signal pin SDA1 of the memory slot 200. The second switch 17 is connected between the terminal corresponding to serial clock signal pin SCL1 of the memory module 300 and the golden finger 14 corresponding to the serial clock signal pin SCL2 of the memory slot 200. The terminals corresponding to the ground pin VSS1, the power pin VDD1 of the memory module 300 are respectively connected to the golden fingers 11 and 13 corresponding to the ground pin VSS2, the power pin VDD2 of the memory slot 200 via traces 18.

In this embodiment, the golden fingers 11-13 are set on a first side of the PCB 10, and the golden finger 14 is set on a second side of the PCB 10 opposite to the first side.

In use, the connecting portion of the card adapter 100 is inserted into one of the memory slots 200 of the computer system 400, the memory slot 15 of the card adapter receives the memory module 300, and the first and second switches 16 and 17 are turned off. At this time, the ground pin VSS2 and the power pin VDD2 of the memory slot 200 are respectively connected to the ground pin VSS1 and the power pin VDD1 of the memory module 300. The serial data signal pin SDA1 and the serial clock signal pin SCL1 are disconnected from the serial data signal pin SDA2 and the serial clock signal pin SCL2 of the memory slot 200. A standard memory module with correct SPD data is inserted into another one of the memory slots 200 of the computer system 400. Then, the computer system 400 reads and saves the SPD data from the standard memory module and runs properly. Then, the first and second switches 16 and 17 are turned on, the serial data signal pin SDA2 and serial clock signal pin SCL2 of the memory slot 200 are connected to the serial data signal pin SDA1 and the serial clock signal pin SCL1 of the first SPD chip 302 of the memory module 300 respectively. Thus, the SPD data of the memory module 300 is corrected in accordance with the SPD of the standard memory module through a program such as SPD Tool. The SPD data correction is well known to those of ordinary skill in the art.

In other embodiments, the position of the golden fingers 11-14 of the connecting portion of the card adapter 100 may be changed according to pins definition of the memory module 300.

Only four pins of the SPD chip 302 of the memory module 300 connect to the card adapter 100, to prevent other components except SPD chip 302 from being damaged during correction. Moreover, the serial data signal pin SDA1 and serial clock signal pin SCL1 of the memory module 300 are respectively connected to or disconnected from the serial data signal pin SDA2 and serial clock signal pin SCL2 of the memory slot 200, that is controlled by the first switch 16 and the second switch 17. To prevent the SPD chip 302 from being damaged due to transient voltage spikes when memory module 300 is plugged into the memory slot 200 of the computer system 400.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A card adapter comprising:
a printed circuit board (PCB) comprising a memory slot to receive a memory module to be corrected, a connecting portion with a plurality of golden fingers to insert into one of memory slots of a computer system; and
first and second switches;
wherein the memory slot of the PCB comprises a plurality of terminals corresponding to the pins of a serial presence detect (SPD) chip of the memory module to be corrected, the golden fingers correspond to pins of the memory slot of the computer system, the first switch is set between the terminal corresponding to the serial data signal pin of the memory module and the golden finger corresponding to the serial data signal pin of the memory slot of the computer system, the second switch is set between the terminal corresponding to the serial clock signal pin of the memory module and the golden finger corresponding to serial clock signal pin of the memory slot of the computer system.

2. The card adapter of claim 1, wherein the terminals corresponding to ground pins and power pins of the memory module are respectively connected to the golden fingers corresponding to ground pins and power pins of the memory slot by traces.
